(19) United States
(12) Patent Application Publication
(10) Pub. No.: US 2005/0131760 A1
(43) Pub. Date: Jun. 16, 2005

(54) Advanced prospecting features for generating targeted business-to-business sales leads and mailing lists

(75) Inventors: Miriam P. Manning, Watertown, MA (US); David Brown, Sudbury, MA (US); Leo T. Maldonado, Somerville, MA (US); Bruce M. McCarthy JR., Acton, MA (US); Mark Asdoorian, Lynn, MA (US); Chet J. Graham, Norwell, MA (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: Dun & Bradstreet, Inc.

(21) Appl. No.: 10/736,770

(22) Filed: Dec. 16, 2003

(51) Int. Cl. G06F 17/60

(52) U.S. Cl. 705/14

(57) ABSTRACT

Advanced prospecting features for generating targeted business-to-business sales leads and mailing lists allow users to save time and money by having the ability to preview all leads prior to purchasing, by suppressing previously licensed lists against new lists, by analyzing a list prior to purchasing it, searching on both primary and secondary standard industry classification (SIC) codes, and by having the ability to dedupe duplicate records in a list.

### BACKGROUND OF THE INVENTION

1. Field of the Invention

The present disclosure generally relates to generating sales leads and mailing lists. In particular, the present disclosure relates to generating targeted business-to-business sales leads and mailing lists, previewing leads prior to purchasing them, suppressing previously licensed lists against new lists, analyzing a list prior to purchasing it, searching on both primary and secondary standard industry classification (SIC) codes, and removing duplicate records in a list.

2. Background of the Invention

Conventional prospecting tools do not allow a user to target a direct marketing program sufficiently or to focus on particular types of businesses. Also, some tools force users to purchase prospect lists without any information about the lists. Others provide lists of the wrong size—too big or too small—or provide lists containing duplicates. In addition, prospect lists often do not have current information. There is a need for a system and method having features for generating targeted business-to-business sales leads and mailing lists that allows users to save time and money by providing the ability to preview all leads prior to purchasing, suppressing previously licensed lists against new lists, analyzing a list prior to purchasing it, and removing duplicate records in a list.

### SUMMARY OF THE INVENTION

The present disclosure is directed to systems and methods for advanced prospecting features for generating targeted business-to-business sales leads and mailing lists that satisfy these and other needs.

One aspect is a method of providing prospect lists. Tools are provided for building a prospect list. A list preview feature is provided for previewing the prospect list prior to providing the prospect list. A list analysis feature is provided for analyzing the prospect list prior to providing the prospect list. The prospect list is provided. In some embodiments, a suppression feature is provided for suppressing a suppression list from the prospect list. In some embodiments, the suppression list is a previously licensed prospect list or an uploaded list. In some embodiments, a dedupe feature is provided for removing duplicate records in the prospect list. In some embodiments, the tools for building a prospect list include a search based on list selection criteria, where the list selection criteria are selected from the group consisting of: location, industry, demographics, specialty data, and job function.

Another aspect is a system for providing prospect lists comprising a web server, at least one database server, a storage device, and an application server. The web server provides a user interface for providing prospect lists. The database server provides access to at least one database having transaction, metadata, and product data. The database server is in communication with the web server. The storage device stores result set data. The application server provides business logic for providing prospect lists. The application server is in communication with the web server, the database server, and the storage device. In some embodiments, the system also comprises a plurality of worker components in communication with the database server, the storage device, and the application server. The worker components include a count engine cluster for determining counts of records, an analysis engine cluster for providing a list analysis feature, a preview engine cluster for providing a list preview feature, an entity look-up engine cluster for performing an entity look-up, and a list fabrication engine cluster for generating a list using said counts. The count engine cluster uses a set of index files in place of product data from the database server, whereby the speed of the count engine cluster is increased. Data preparation steps are periodically performed on new data to produce data files for the list analysis feature, whereby the speed of the list analysis feature is increased. A layout of the data files comprises an order by record index so that each record of the data files is directly accessible by record index.

Another aspect is a computer-readable medium having executable instructions stored thereon to perform a method of providing previews of prospect lists. A list is sorted based on user-selected criteria. A portion of the sorted list is provided as a preview. A selective delete feature is provided for deleting elements of the sorted list from the preview. The list is provided and that list has the selected elements removed. The list, deleted elements, and preview are stored. In some embodiments, the portion includes a company name and location.

Another aspect is a computer-readable medium having executable instructions stored thereon to perform a method of suppressing lists from prospect lists. A current prospect list is built based on list selection criteria. Elements in a suppression list are removed from the current prospect list to generate a new prospect list. The new prospect list is provided. In some embodiments, the suppression list is stored. In some embodiments, the suppression list is a previously acquired list or an uploaded list. In some embodiments, the uploaded list is processed using a conversion table to produce a list result set having unique corporate identifiers. The list result set is associated with a user account. In some embodiments, the unique corporate identifiers are associated with elements in the uploaded list through application of a matching process.

Another aspect is a computer-readable medium having executable instructions stored thereon to perform a method of providing list analysis for prospect lists. An analysis data file and a list result set is received. A list of companies is processed by looking up data in the analysis data file and aggregating the data based on selected fields. At least a portion of the aggregated data is provided. In some embodiments, the aggregated data is stored in a result set file. In some embodiments, more than that portion is available for display without further processing. In some embodiments, the data files are ordered by record index so that each record of the data files is directly accessible by record index and the record index is included as a data item in each record.

Another aspect is a computer-readable medium having executable instructions stored thereon to perform a method of providing counting items in prospect lists. A list is received. A result set corresponding to the list is retrieved. Any suppression lists or delete lists referenced in the list are retrieved. The list is combined with any suppression lists or delete lists to form a combined list and the combined list is provided. In some embodiments, the combined list is deduped, upon request. In some embodiments, the result set is converted using a conversion table, if a data update occurred after the result set was stored.

### BRIEF DESCRIPTION OF THE DRAWINGS

These and other features, aspects, and advantages of the present disclosure will become better understood with reference to the following description, appended claims, and drawings where:

FIG. 1 is a block diagram of an example system architecture capable of operating a service for generating a prospect list;

FIG. 2 is a screenshot of an example user interface for providing a prospect list;

FIG. 3 is a screenshot of an example user interface for generating a prospect list;

FIG. 4 is a screenshot of an example user interface for a suppression feature;

FIG. 5 is a screenshot of an example user interface for a list analysis feature;

FIG. 6 is a screenshot of an example user interface for a list preview feature;

FIG. 7 is a screenshot of an example user interface for a dedupe feature;

FIG. 8 is a screenshot of an example user interface for a search on primary and secondary standard industrial classification (SIC) code feature;

FIG. 9 is a logic flow diagram of an example list preview process;

FIG. 10 is a logic flow diagram of an example suppression process;

FIG. 11 is a logic flow diagram of an example list analysis process; and

FIG. 12 is a logic flow diagram of an example count process.

### DETAILED DESCRIPTION OF THE PREFERRED EMBODIMENTS

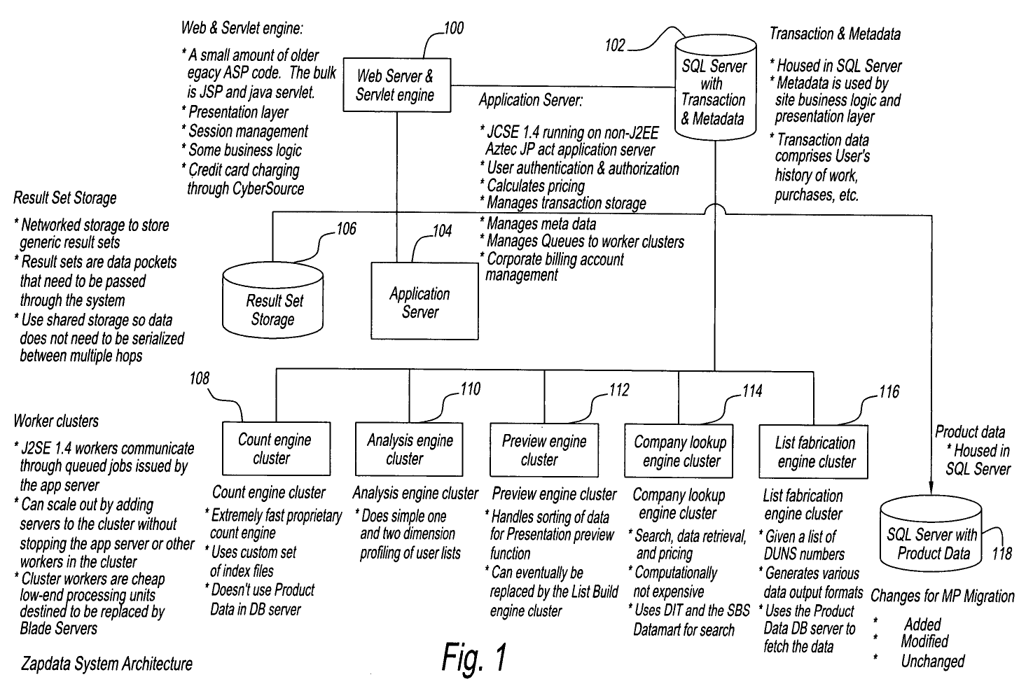

FIG. 1 shows an example system architecture capable of operating a service for generating a prospect list. In this example, a web server and servlet engine 100 include a presentation layer, session management, business logic, and billing components. Web server and servlet engine 100 is in communication with a structured query language (SQL) server with transaction and metadata 102. SQL server 102 provides metadata that is used by the business logic and presentation layer. Transaction data comprises a user's history of work, list acquisitions, and the like. Web server and servlet engine 100 is also in communication with an application server 104. Application server 104 provides user authentication and authorization, calculates pricing, manages transaction storage, data, queues to worker clusters, and billing accounts. Web server and servlet engine 100 has access to a storage device, result set storage 106, via a network. Result set storage 106 stores generic result sets. Result sets are data packets that need to be passed through the system. Shared storage is used so that data does not need to be serialized between multiple hops as a result set is passed between system components. For example, a result set generated by the count engine is passed to the queue and then to web server 100. If the user wants to do an analysis, web server 100 passes the result set back to the queue, which passes it to analysis engine cluster 110.

In this example, there are a plurality of java 2 enterprise edition (J2EE) worker clusters in communication with result set storage 106 and application server 104. The worker clusters include: a count engine cluster 108, an analysis engine cluster 110, a preview engine cluster 112, an entity look-up engine cluster 114, and a list fabrication engine cluster 116. These worker clusters communicate through queued jobs issued by application server 104. Worker clusters are processing units or servers. Additional worker clusters are included in some embodiments. Count engine cluster 108 uses a custom set of index files and does not use the product data in SQL server 118 in order to operate quickly. Analysis engine cluster 110 performs one and two dimension profiling of user lists. Preview engine cluster 112 sorts data for presentation. Entity look-up engine cluster 114 performs entity look-ups, data retrieval, and pricing functions using information from a data integration toolkit and a small business service, which are available from Dun & Bradstreet. In some embodiments, entity look-up engine performs entity look-ups one-at-a-time. List fabrication engine cluster 116 generates various data products for a given list of companies identified by a unique corporate identifier, such as a DUNS number. List fabrication engine cluster 116 also uses product data from SQL server 118.

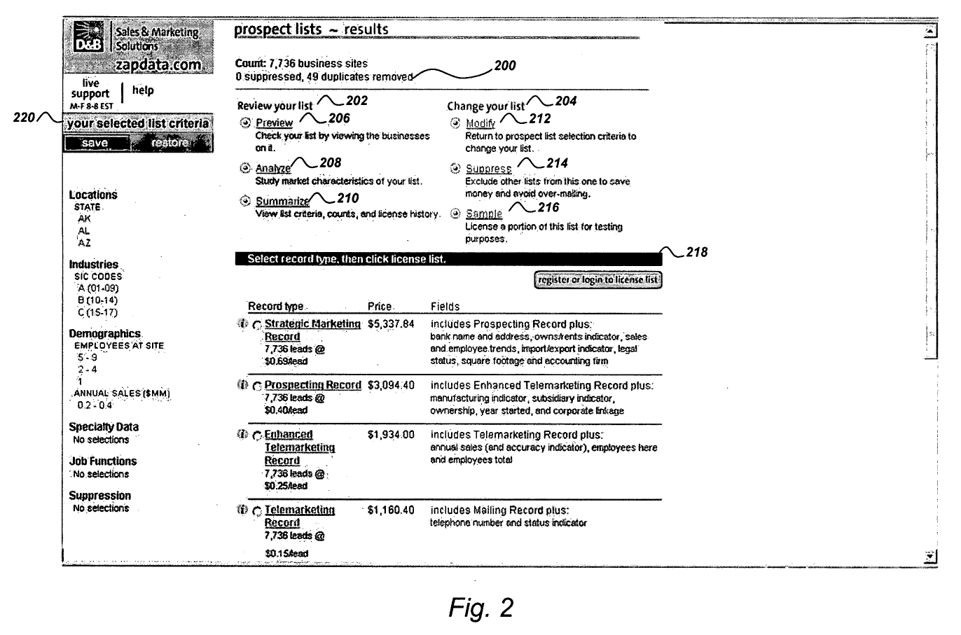

FIG. 2 shows an example user interface for providing a prospect list. In this example, the results of a search for the prospect list are displayed, where the list includes a count of 7,736 business sites with 0 suppressed and 49 duplicates removed 200.

Options are provided for the user to review the list 202 or change the list 204. Review options 202 include preview 206, analyze 208, and summarize 210. Preview 206 allows the user to check the list by viewing limited information about the list, such as business names. Analyze 208 allows the user to study market characteristics of the list. Summarize 210 allows the user to view list criteria, counts, and license history. List criteria are the criteria used by a search to create the list results. Counts are the number of results in the list. License history is a history of previous lists that were licensed. Change list options 204 include modify 212, suppress 214, and sample 216. Modify 212 allows the user to return to the list selection criteria used to generate the current list and change them. Suppress 214 allows the user to exclude other lists from this one to save money and avoid over-mailing. Sample 216 allows the user to license a portion of the list for testing purposes.

Licensing options 218 are provided to the user with various record types, prices, and fields in the records. The list selection criteria 220 used to generate the current list are displayed.

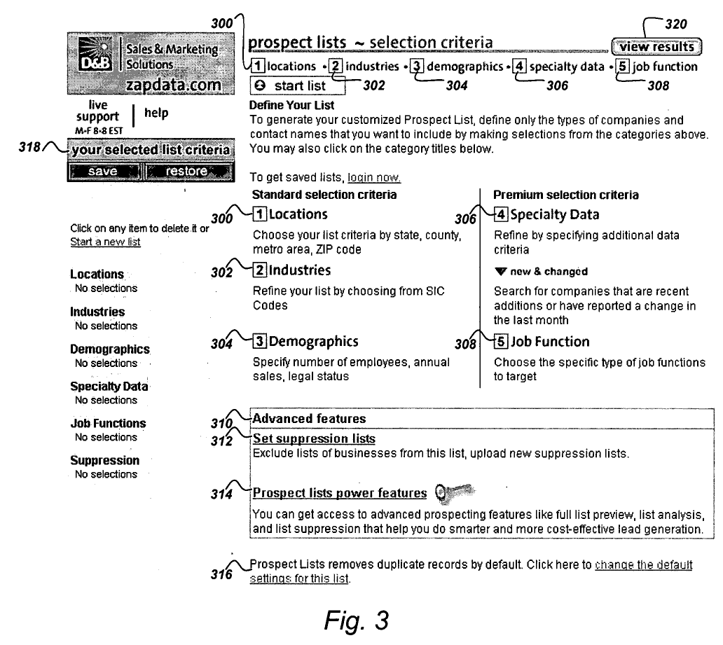

FIG. 3 shows an example user interface for generating a prospect list. The user selects criteria and then a search is performed based on the list selection criteria to generate a prospect list. In this example, there are five different kinds of list selection criteria: location 300, industries 302, demographics 304, specialty data 306, and job function 308. Location criteria include state, country, metro area, and zip code. Industries criteria include standard industrial classification (SIC) codes, including drilling down to the 8-digit SIC code level. Demographics criteria include number of employees, annual sales, and legal status, years in business, public or private, location of headquarters, and other information. Specialty data criteria include estimated number of PCs, business indicators, fax numbers, new and changed records, and other information, companies that are recent additions or have reported a change in the last month. Job function criteria include types of job functions, such as restaurant manager or VP or Marketing.

Advanced features 310 include suppression 312 and other features 314. Suppression 312 allows the user to exclude lists of businesses from the current list and to upload new suppression lists. Other features 314 include list preview and list analysis. Duplicate records are removed from generated lists by default and an option is provided to change default settings 316.

As the user builds list selection criteria they are displayed on the left 318. Once the user has selected all the list selection criteria, the user clicks on a button 320 to generate the prospect list based on the list selection criteria.

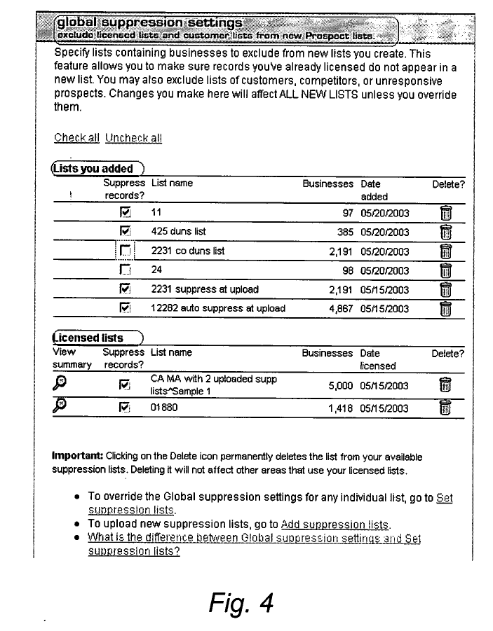

FIG. 4 shows an example user interface for a suppression feature. In this example, the user is provided with options for excluding licensed lists and customer lists from new prospect lists. This suppression features allows the user to specify previously acquired lists to exclude from the new lists created by the user. This allows the user to make sure records that the user has already licensed do not appear in a new list. Also, the user is able to exclude lists of customers, competitors, or unresponsive prospects. These lists are uploaded to the site by the user and processed to be made available in the user's account as a suppress list. The user is able to both set global suppression settings, which apply to all lists, and set specific suppression lists, which apply to a single list. List suppression allows the user to save money on every list the user licenses by, for example, never mailing to the same business twice. For example, the user is able to exclude all records in previously acquired licensed lists and/or exclude the user's own in-house lists, e.g., a customer file or a do-not-call list, from all the new prospect lists.

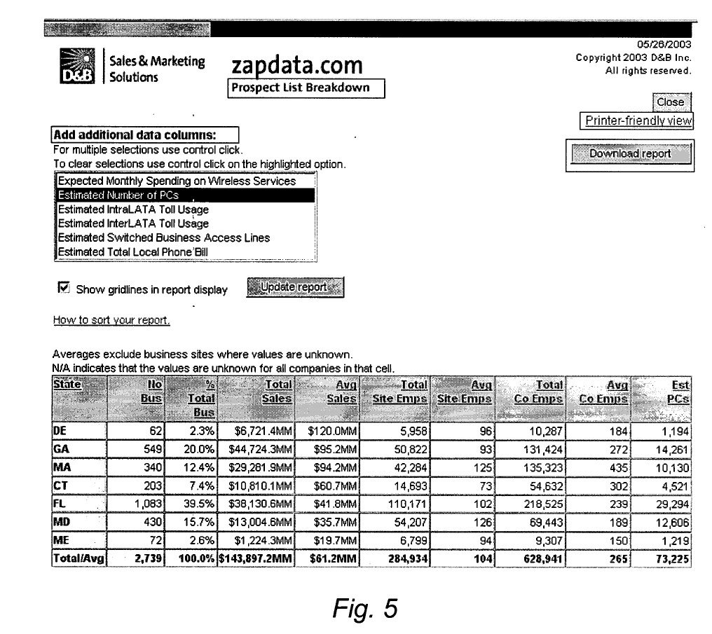

FIG. 5 shows an example user interface for a list analysis feature. In this example, the user is able to create, view, and print list breakdown and crosstab reports to help with the list buying decisions. This analysis is used to print a report for a boss or client for approval, to ensure a reasonable distribution of records by geography, industry, or size, to verify sufficient coverage within a target market, and to compare potential sales territories.

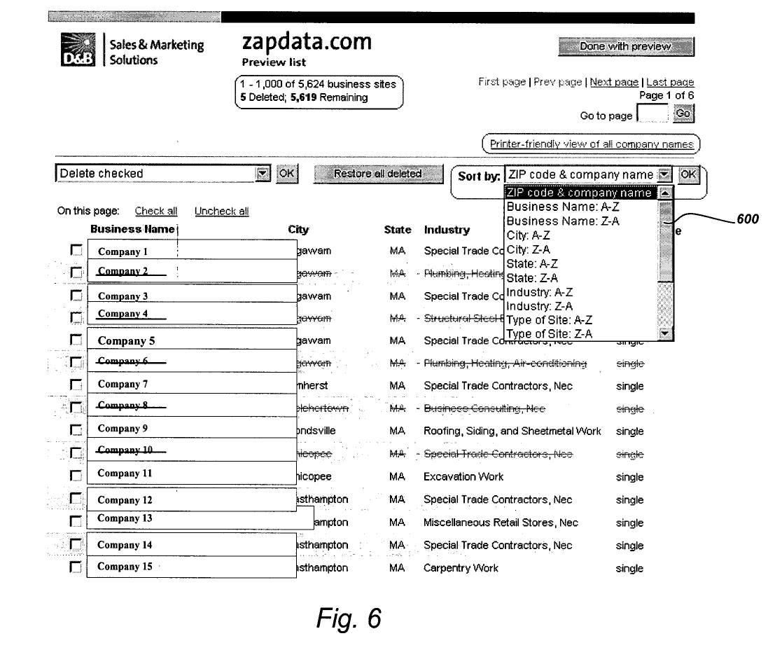

FIG. 6 shows an example user interface for a list preview feature. In this example, the user is able to see some information about the prospect list before buying it and delete unwanted records. Also, the user is able to sort the list by company name, size, location, and other characteristics 600. This way, the user is able to make sure the list is targeted to the desired market before purchasing it.

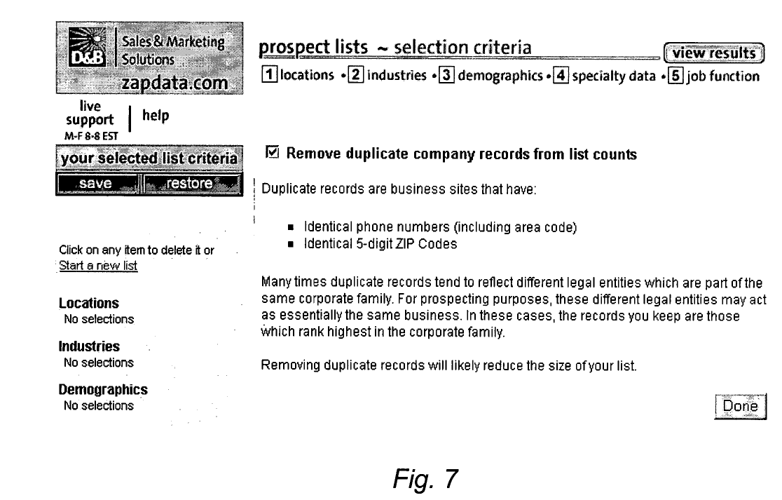

FIG. 7 shows an example user interface for a dedupe feature. To dedupe is to remove duplicate records from the current list. In this example, the user is able to save money and prevent duplicate mailings. Some records reflect different legal entities, which are, for marketing purposes, the same business. This feature automatically retains only the record highest on the corporate ladder if there is more than one record at the same 10-digit phone number within the same zip code.

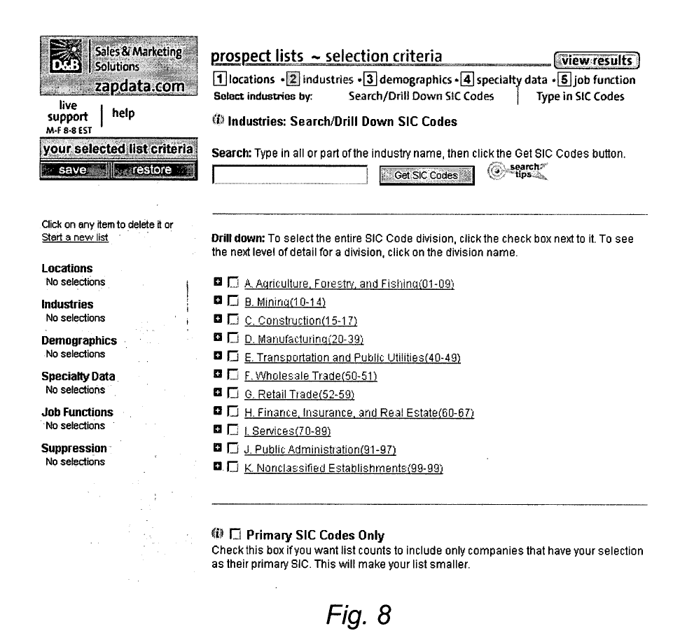

FIG. 8 shows an example user interface for a search on primary and secondary SIC code feature. In this example, the user is able to search based on both a primary and a secondary SIC or only a primary SIC. Also, the user is able to drill down SIC codes.

In an example embodiment, a method for providing prospect lists has the following features: list suppression, list analysis, list preview, company dedupe, and searching on primary and secondary SIC code. This method is provided as a service on a web site that is available for a fee or subscription. Other embodiments are provided through various other delivery mechanisms, such as a downloadable program, a program on CD, a business service, and the like.

In this example, with list suppression, users are able to exclude certain types of records from a prospect list the user creates. For example, the user can exclude a supplied list of records, such as a customer file or a previously licensed list of records.

In this example, the list suppression feature meets the needs of marketing users to have efficient mailings. Marketing users want to eliminate customer records from a planned promotion to prospects. They want to avoid the expense of licensing records more than once. They want to eliminate records already promoted to from a planned promotion to prospects. They want to ensure undesirable market segments are not included in promotions.

In this example, the list suppression feature also meets the needs of sales users to save money, time, and embarrassment. Sales users want to avoid calling on companies who are already customers. They want to avoid the expense of licensing records more than once. They want to exclude competitors and other undesirable companies from their lists.

In this example, the list suppression feature further meets the needs of internal users by enabling them to provide unique records. Internal users want to provide only unique records to the customer compared with previous orders. They want to exclude certain previous orders specified by the customer.

In this example, a suppression list is a set of records that is excluded from a prospect list. As part of the list definition process, a user chooses to set suppression options. Suppression options become part of the list selection criteria and are saved with them for later restoration. Like any other criteria, they are changeable for a list at any time before licensing.

In this example, once a user sets the suppression options for a particular list, displays do not include the suppressed records. A list of available suppression lists is provided.

In this example, there are two types of suppression lists: (1) a supplied list and (2) a previously licensed list. The user specifies any number of suppression lists for a given list. Users upload the supplied lists in a secure environment and the information is processed by interactive matching and assignment of unique corporate identifiers, such as a DUNS Number™. There is a fee for uploading and making use of lists. In general, fees include many pricing schemes, such as per use or subscription fees. Supplied lists support the marketing and sales users desire to exclude customers, companies on do-not-call lists, or acquired lists from other sources prior to licensing.

In this example, a sales proxy user is able to supply a list for suppression on behalf of any user. While the sales proxy user is logged in, they submit a suppression list and associate it with another user. The other user is notified and the list is sent to their account by the proxy user for their approval.

In this example, suppressing previously licensed lists simply and easily eliminates spending on records that were already acquired. When the user licenses a first list, the user is given an option to set a suppression default for the first list. If the default is set to suppress, then whenever the user licenses a second list, records from the first list are excluded from the second list, unless the user overrides the default. The default setting is off and the user must actively choose to suppress records from future lists.

In this example, the following information is logged: a list of the suppression lists the user used for a count, how many total records were suppressed from the list, and a table of all the user's suppression lists, including default settings.

In this example, with the list analysis feature, the user creates, views, prints, and saves list breakdown and crosstab reports to help the user with buying decisions. The user is able to retrieve a report in a spreadsheet. List analysis meets the need of users to have detailed reports that are printable, emailable, or in spreadsheet format, and easy to generate. Various pieces of analysis are available according to various pricing schemes, such as by subscription, per item, and the like.

In this example, the list analysis feature meets the needs of marketing users. Marketing users want to provide a printed or emailed report on a proposed list to the user's boss for approval. They want to ensure a reasonable distribution of records by geography, SIC, or size, before licensing. They want to verify coverage of contact names across the list. They want to verify there are sufficient records within their target market in a geographic region to help make branch location or territory assignment decisions. They want to provide an overview of the target market for management. They want to look at different segments of a large list to decide which ones to license in a new, smaller list.

In this example, the list analysis feature meets the needs of sales users. Sales users want to compare potential geographical sales territories. They want to understand the weighting of prospects by SIC, size, or geography within their territory and target market. They want to verify there are sufficient records within their target market in a geographic region to help make branch location or territory assignment decisions. They want to look at different segments of a large list to decide which ones to license in a new, smaller list.

In this example, the list analysis feature meets the needs of internal users. Internal users want to provide a faxed or emailed report on a proposed list to the customer for approval and/or list modification. They want to ensure a reasonable distribution of records by geography, SIC, or size, before licensing. They want to verify coverage of contact names across the list.

In this example, once a count is obtained for a list, the user is provided with an option to request a list breakdown or crosstab report on the records in the list. The user is able to request multiple reports with different options on a single list at any time. Such a report is helpful for refining list selection criteria. A report is accessible on any unlicensed set of criteria having a count, including a freshly created set of criteria, a saved and restored set of criteria, a restored set of criteria from an acquired list, and an unlicensed sample from a sample/remainder list. The crosstab report is built from any two data elements. One data element defines the rows for the analysis and the other data element defines the columns for the analysis. A third data element is used to populate the cells of the crosstab report. The list breakdown report provides standard columns of information broken down by one of several fields, including business statistics. Both reports are formatted for viewing, printing, spreadsheet programs, email programs, and the like. Both reports are storable and downloadable by the user. Default settings are used to create the reports quickly, but the user is able to specify some settings, if desired. For example, a list of 100,000 records sorted by SIC4 are provided in no more than one minute and large crosstab reports of 5 million records sorted by SIC4 and county in TX are provided in no more than five minutes.

In this example, the following information is logged: whether the user used crosstabs or breakdowns, the time to generate the report, whether the report was downloaded, what fields were chosen for certain aspects, and the like.

In this example, with the list preview feature, the user sorts, reviews, and prints available information on records in a list. The user is able to review and change delete settings for records in the list. The list preview feature meets the needs of marketing users, sales users, and internal users.

In this example, the list preview feature meets the needs of marketing users, who want to feel good that the list is what was expected and to easily print or export the preview information. In some embodiments, exporting is limited to prevent copying information to other applications. Marketing users want to “eyeball” the list to feel comfortable that it has the right sort of companies in it. They want to show some information on each record to their boss for approval. They want to remove certain records from the list, such as competitors, and members of their own corporate family.

In this example, the list preview feature meets the needs of sales users, who want to easily find particular records, delete records, and license deeper information on individual records. Sales users want to “eyeball” the list to feel comfortable that is has the right sort of companies in it. They want to remove certain records from the list, such as competitors, unlikely prospects, and members of their own corporate family. They want to create a list of a few specific companies from another list defined by demographics.

In this example, the list preview feature meets the needs of internal users, who want to easily skip the preview. Internal users are not customers. Internal users sometimes want to remove certain records specified by the customer.

In this example, the list preview allows the user to quickly scan the records in the list and make themselves feel comfortable that the records in the list are the kinds of companies they expected. In some embodiments, an upper limit on the number of records in a preview is set based on usage statistics gathered over time. A limited number of fields are displayed for each record in the preview, such as legal name, trade style name, city, state, SIC4 description, and the like. Suppose a user wants to build of restaurants in Massachusetts. Under demographics, the user selects only restaurants with at least ten employees and job function of restaurant owner. The user views preview to see the result is a list of 300 records, which is associated with a cost. Suppose the user knows there are several restaurants that will not use the user's product and the user does not want to pay for that information. In the preview, the user finds them by name and deletes them from the list.

In this example, count information is provided with a preview for the following: count of records now in the list, count of deleted records, and count of deduped records.

In this example, the user is able to delete, undelete, check all, uncheck all, restore all deletes and perform other actions with a preview. With delete, the user is able to remove checked records from a list. Deleted records are indicated by strikeout or graying out. With undelete, the user is able to restore deleted records. With check all and uncheck all, the user is able to select or deselect all the records for an action, such as restoring deleted records.

In this example, the user is able to sort records with a preview. This allows a user to bring records of interest to the top of a list quickly. For example, a user sorts by annual sales, number of employees, and the like. Sorting options are storable and have default values. The preview is available for output, such as printing and copying to other applications, such as a spreadsheet application.

In this example, the following information associated with the list preview feature is logged: whether the user used the list preview, how many, if any, records were deleted or restored, whether the user used a print-friendly view, whether the user sorted the list, what sort criteria the user used, how long the sort took, and other information.

In this example, with the company dedupe feature, the user is able to remove duplicate records from a list prior to licensing. The company dedupe feature allows the user to avoid sending multiple mail pieces to a single business with multiple records in the list. This avoids wasting money and embarrassment. There is an option to dedupe a list at a company level. This means that if more than one record has the same 10-digit phone number within the same zip code, then only one of the records is retained in the list. Duplicates are removed based primarily on a hierarchy code from a corporate linkage component. The record with the lowest hierarchy code, e.g. value of 1, is kept in the list, while all the other duplicates are removed. If multiple records have the same hierarchy code or if there is no hierarchy code, then an arbitrary determination is made. The count reflects the deduping. Records removed through deduping are not displayed or reported, unless a data update changes the criteria used to dedupe them. If a suppression list is deduped, then the removed records are not suppressed from any list which includes that list as a suppression list. Whether the user used dedupe, which is captured as part of the criteria log is logged.

In this example, with the searching on primary and secondary SIC code feature, the user searches for a particular list. This feature meets the needs of marketing, sales, and internal users by providing a way to maximize counts without taking action. By default, searches include companies with primary or secondary SICs matching the criteria set by the user. However, the user has the ability to search on primary SIC only for a particular list. Whether the user used primary SIC only is logged.

In an example embodiment, a system for providing prospect lists has the following features: list suppression, list analysis, list preview, company dedupe, and search on primary and secondary SIC code.

In this example, with the list suppression feature, when a user licenses a first list, a first list of records are stored and associated with the user's account. Later, when the user builds a second list, a count process in the system loads the first list of records and suppresses the first list of records from the second list of records. The system loads the first list of records and the count process processes the first list of records and removes them from the second list of records. When the user uploads a suppression list, the system converts the uploaded suppression list to a list of records and stores them.

In this example, with the list analysis feature, once the user requests list analysis from the web server, an analysis engine uses the data files and the list of records that represents the list to be analyzed and generates a report, such as a breakdown report by state. The report is stored as a temporary result set and sent to the web server, which provides the report to the user.

In this example, the system performs data preparation steps periodically on new data to produce data files for performing list analysis quickly. The data files are stored in such a way as to provide quick retrieval optimized for analysis by particular data items, such as location, industry, or number of employees. Table 1 shows an example analysis data layout file format in a fixed-length record file with a total record size of 110 bytes. The file is ordered by record index so it can be directly accessed by record index. The record index is also included as a data item in the row for reference purposes. The specific fields in the file are data-driven by metadata. The list of fields in a configuration file specifies which fields the list are capable of being analyzed by and the fields are capable of being aggregated in the analysis feature. The data file is generated periodically, such as monthly based on that field list.

TABLE 1
Analysis Data Layout

| Byte index in | | Data | Data |
|---|---|---|---|
| the record | Data field | type | length |
| 0 | Lir | Int | 4 |
| 4 | State code | Int | 2 |
| 6 | MSA code | Int | 2 |
| 8 | County code | Int | 4 |
| 12 | 3-digit zip code | Int | 2 |
| 14 | 5-digit zip code | Int | 4 |
| 18 | SIC division code | Int | 2 |
| 20 | 2-digit SIC code | Int | 2 |
| 22 | 3-digit SIC code | Int | 4 |
| 26 | 4-digit SIC code | Int | 2 |
| 28 | 6-digit SIC code | Int | 4 |
| 32 | 8-digit SIC code | Int | 4 |
| 40 | Employees here range code | Int | 2 |
| 46 | Employees total range code | Int | 2 |
| 36 | Employees here | Int | 4 |
| 42 | Employees total | Int | 4 |
| 48 | Sales (scaled to $ 100 k) | Int | 8 |
| 56 | Sales range code | Int | 2 |
| 58 | Years in business range code | Int | 2 |
| 60 | Headquarters/single/branch code | Int | 2 |
| 62 | Est nodes range code | Int | 2 |
| 64 | Est PCs | Int | 4 |
| 68 | Est PCs range code | Int | 2 |
| 70 | Est switched lines | Int | 4 |
| 74 | Est switched lines range code | Int | 2 |
| 76 | Intralata toll usage | Float | 4 |
| 80 | Intralata toll usage range code | Int | 2 |
| 82 | Interlata toll usage | Float | 4 |
| 86 | Interlata toll usage range code | Int | 2 |
| 88 | Local phone bill | Float | 4 |
| 92 | Local phone bill range code | Int | 2 |
| 94 | Broadband potential code | Int | 2 |
| 96 | Expected wireless spending | Int | 4 |
| 100 | Expected wireless spending range | Int | 2 |
| | code | | |
| 102 | Likelihood to switch providers | Int | 2 |
| | code | | |
| 104 | Est copy volume range code | Int | 2 |
| 106 | Est print volume range code | Int | 2 |
| 108 | Est IT expenses range code | Int | 2 |

In this example, the analysis result set comprises an analysis report for each output field analyzed by the breakdown or crosstab field specified by the user. This allows the user to switch quickly between different output fields. The data layout is a variable-length record that depends on the number of output fields and whether the user chose a breakdown or crosstab report. Each section uses fixed-length sub-records to allow for fast indexing into the file. Table 2 shows the generic format.

TABLE 2
Analysis Result Set Layout

```
short - type of analysis (1 for breakdown, 2 for crosstab)
byte[40] - analyze-by key for the rows
byte[40] - analyze-by key for the columns (for crosstab only)
short - # output fields
for each output field:
    short - aggregation type (0 for count, 1 for sum, 2 for average,
    3 for percent of count, 4 for percent of sum)
    byte[40 ] - key for the analysis field associated with the
    output field
int - # rows
for each row setting (sorted)
    int - value of settings for rows
int - # columns - for crosstab only
for each column setting (sorted)
    int - value of settings for columns (for crosstab only)
analysis type-specific format for the data -- see below
Breakdown analysis data format
    output field 1 for row value 1, output field 2 for row value 1, ...
    output field 1 for row value 2, output field 2 for row value 2, ...
    .
    .
    .
    output field 1 total, output field 2 total, ...
Crosstab analysis data format
    output field 1 for row value 1 column value 1, output field 1 for
    row value 1 column value 2, ..., output field 1 total for row value 1
    output field 1 for row value 2 column value 1, output field 1 for
    row value 2 column value 2, ..., output field 1 total for row value 2
    .
    .
    .
    output field 1 total for column value 1, output field 1 total column
    value 2, ..., output field 1 grand total
    .
    .
    .
    output field n for row value r column value 1, output field n for
    row value r column value 2, ..., output field n grand total
```

In this example, the result set system efficiently passes generic result sets between system components. The result set sometimes has to make more than one hop between end components that produce or use the data in the result set. This is accomplished by using shared network storage that all system components have access to. There is a shared database that manages information about result sets, assigns identifiers, determines whether the result set is temporary or permanent, and performs other functions.

In this example, the result set system allows systems to share result sets without having to do one of the following: (1) serialize the entire results over the one or more hops sometimes needed to get to the final user of the results or (2) pass a remote reference to a result object that would not be guaranteed to still exist by the time the user of the result set accesses the results. Instead, the result set system allows providers of result sets to store their data in a result set store. The store is hidden from users of the result set system and accessed via java input/output (IO) streams. Providers of result sets extend a result set class, which provides access to the result set store as well as a database for storing result set meta data. The result set class also maintains an identifier for the result set that is usable by external systems to store a reference to the result set.

In this example, result sets have one of three states: newly-created, saved, or permatized. Newly-created result sets that have not yet had their data saved, are not passed via serialization. Newly-created result sets are assigned an identifier, but are not complete result sets yet. Saved result sets have their data saved and are capable of being passed via serialization. However, when a user's session expires, the result set is cleaned up. Permatized result set are made permanent and are cleaned up by application level code. Permatized result sets last across data updates. In some embodiments, each data item in a result set is stored in a separate file on a file system accessible by all system components. The data is defined as transient in the result set class so that during serialization, only the identifier of the result set is serialized.

In this example, there are three types of result sets: preview sort result sets, analysis result sets, and list result sets. The list result set includes a set of companies in a list as well as count data, including intermediate counts provided to the user, e.g., the count of suppressed records. The list result set, unlike the preview sort result set and analysis result set, is permatized. During permatization, the set of record identifiers is converted to a list of DUNS Numbers so that when a data update occurs and record identifiers change, the list of record identifiers in the new month's data is capable of being generated. This conversion is performed using a fixed-width record file of one 4-byte DUNS Number per record that is directly indexed by record identifier. The state of a list result set is stored in a database and during data updates, the record identifier set flag is cleared so that the next time the result set is accessed, the record identifiers will be re-generated from the DUNS Numbers. This conversion is performed using a fixed-width record file of 8-bytes. The first 4 bytes are the DUNS Number and the second 4 bytes are the record identifier. The file is sorted by DUNS Number and accessed using a standard binary search algorithm.

In this example, with the list preview feature, the system handles delete requests and sorting and displaying the list. When the user selects records to delete, the system stores in memory a temporary set of records to be deleted. Once the user has selected all the records to delete, the system performs a list count removing the records marked for delete and stores that set of deleted records as a result set. If the user saves the list and views it later or licenses it, the deleted records result set is permatized. The system has a cache of the preview data on the website to avoid querying a database.

In this example, Table 3 shows an example preview display data layout in a fixed-length record file with a total record size of 145 bytes. The file is ordered by record index so that it is directly accessible by record index. The record index is also included as a data item in the row for reference. The specific fields in the file are data-driven by metadata. The list of fields in a configuration file specify which fields are displayed in the preview feature. The data file is generated monthly based on that field list. This file is used as a cache of the preview data on the website to avoid querying a database in order to display a preview.

TABLE 3
Preview Display Data Layout

| Byte index in the | | | |
|---|---|---|---|
| record | Data field | Data type | Data length |
| 0 | Record index | Int | 4 |
| 4 | Business name | Char | 30 |
| 34 | City | Char | 25 |
| 59 | State | Char | 2 |
| 61 | Sic4 Description | Char | 72 |
| 133 | Headquarters/single/branch | Char | 12 |

In this example, Table 4 shows an example preview sort data layout in a fixed-length record file with a total record size of 161 bytes. The file is ordered by record index so that it is directly accessible by record index. The record index is also included as a data item in the row for reference. The specific fields in the file are data-driven by metadata. The list of fields in a configuration file specify which fields are sortable in the preview feature. The data file is generated monthly based on that field list.

TABLE 4
Preview Sort Data Layout

| Byte index in | | | |
|---|---|---|---|
| the record | Data field | Data type | Data length |
| 0 | Record index | Int | 4 |
| 4 | Business name | Char | 30 |
| 34 | City | Char | 25 |
| 59 | State | Char | 2 |
| 61 | Sic4 Description | Char | 72 |
| 133 | Headquarters/single/branch | Char | 12 |
| 145 | Employees at site | Int | 4 |
| 149 | Employees total | Int | 4 |
| 153 | Sales | Double | 8 |

In this example, Table 5 shows an example preview sort result set that contains a sorted list of record indexes. It is a fixed-width record file with only a single field per record. The total record size is 4.

TABLE 5
Preview Sort Result Set Layout

| Byte index in the record | Data field | Data type | Data length |
|---|---|---|---|
| 0 | Record index | Int | 4 |

In this example, with the company dedupe feature, the system performs the dedupe process dynamically when a count process is performed by the count engine. The result set for the list is ordered by hierarchy code, which identifies a corporate parent in a corporate hierarchy from a corporate linkage component. The count engine iterates over the result set and groups them based on phone number and zip code. For each group that has a count of records greater than one, a ranking is applied and all but the top company for each group is removed. That is the dedupe process. A count of the number of records removed during dedupe is provided to the user.

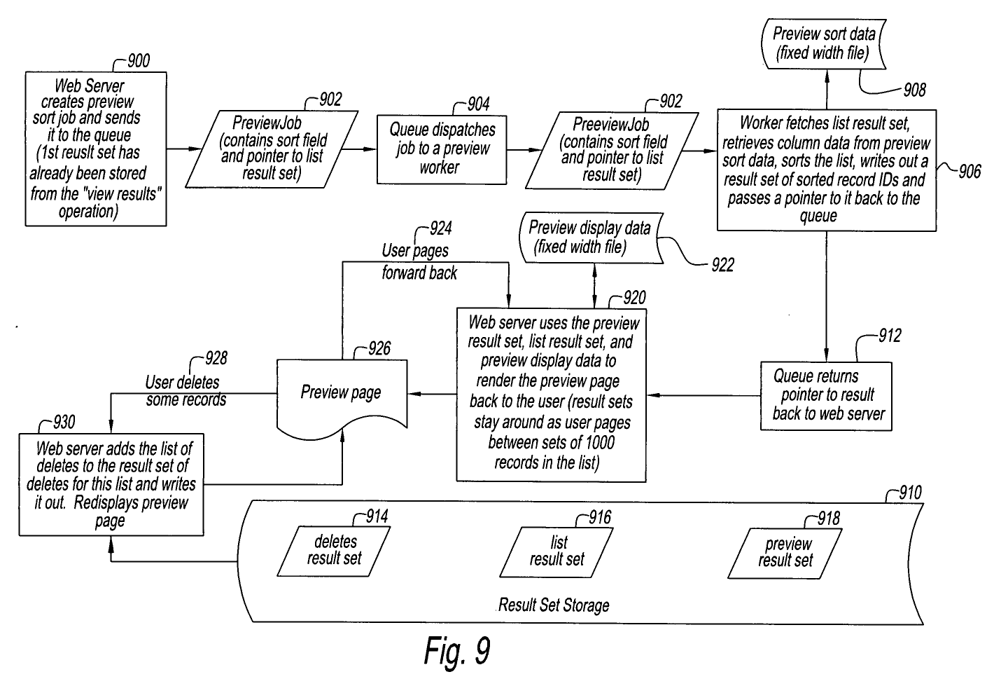

FIG. 9 shows an example list preview process. In step 900, a web server creates a preview sort job 902 and sends preview sort job 902 to a queue. Preview sort job 902 contains a sort field and a pointer to a list result set 916. When this occurs, list result set 916 has already been stored as a result of a view results operation requested by the user. In step 904, the queue dispatches preview sort job 902 to a preview worker. In step 906, the preview worker fetches list result set 916, retrieves column data from preview sort data 908, which is a fixed width file. The preview worker then sorts the data to produce a list of record identifiers sorted by the data item, writes out a result set 910 of those sorted record identifiers, and passes a pointer to it back to the queue. In step 912, the queue returns a pointer to result set 910 back to the web server. Result set 910 is stored in a storage device and includes deletes result set 914, list result set 916, and preview result set 918. In step 920, the web server uses preview result set 918, list result set 916, and preview display data 922 to render the preview page 926 back to the user. Result sets persist while the user pages 924 between sets of 1000 records in the list. If the user deletes some records 928, in step 930, the web server adds a list of deletes to deletes result set 914 for this list and writes it out. Also, the web server re-displays the preview page, marking the deleted records appropriately.

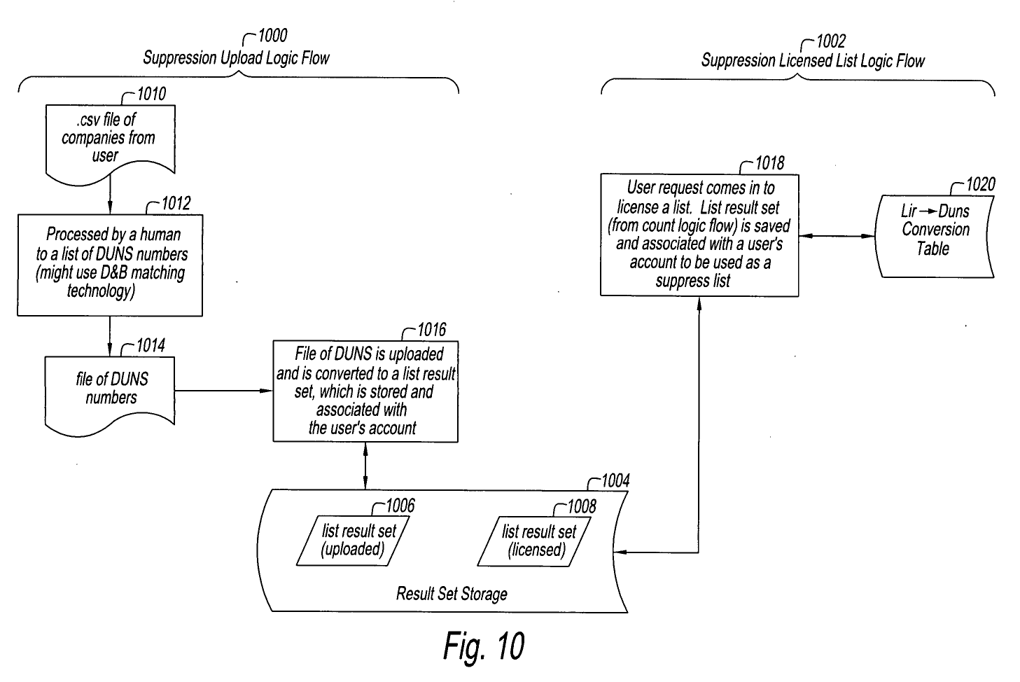

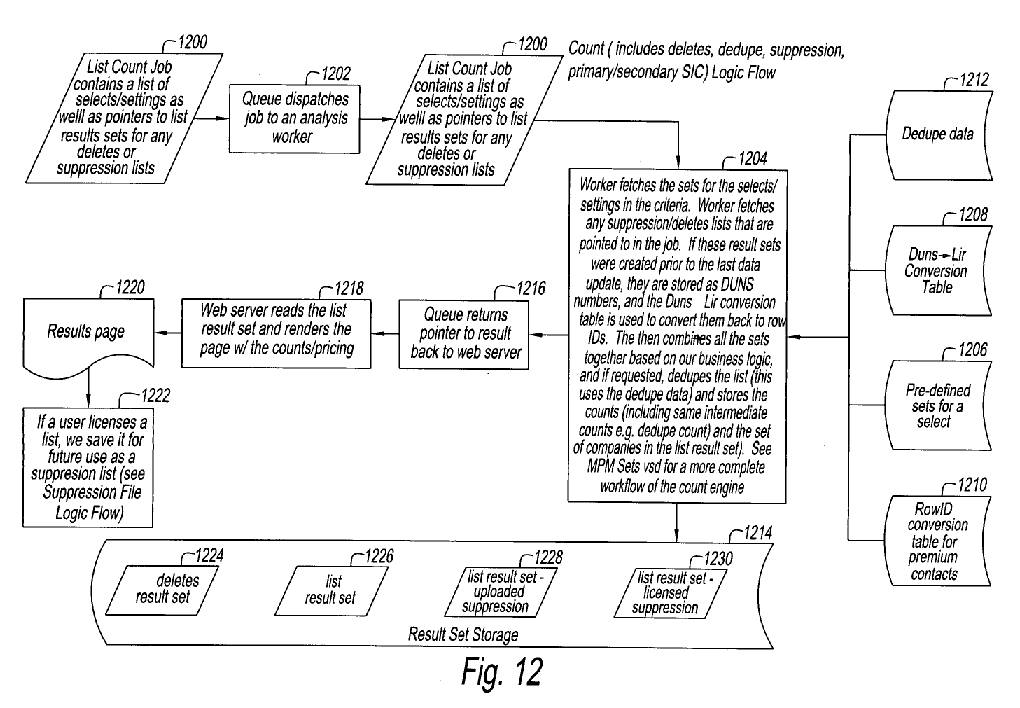

FIG. 10 shows an example suppression process for suppression files that are either uploaded 1000 or licensed 1002. A result set storage 1004 includes a list result set for uploaded files 1006 and a list result set for licensed files 1008. For suppression files that are uploaded 1000, a command separated values (.csv) file of companies is received from the user in step 1010. In step 1012, this file is processed by a human to a list of DUNS Numbers. Sometimes, the file is processed by a matching process. The result is a file of DUNS Numbers 1014. In step 1016, this file of DUNS Numbers is uploaded an converted to list result set 1006, which is stored and associated with the user's account. For licensed lists, in step 1018, a user request comes in to license a list. List result set 1008 (Set FIG. 12) is saved and associated with the user's account to be used as a suppression list. The process of saving converts record identifiers to DUNS Numbers. This conversion uses a conversion table 1020.

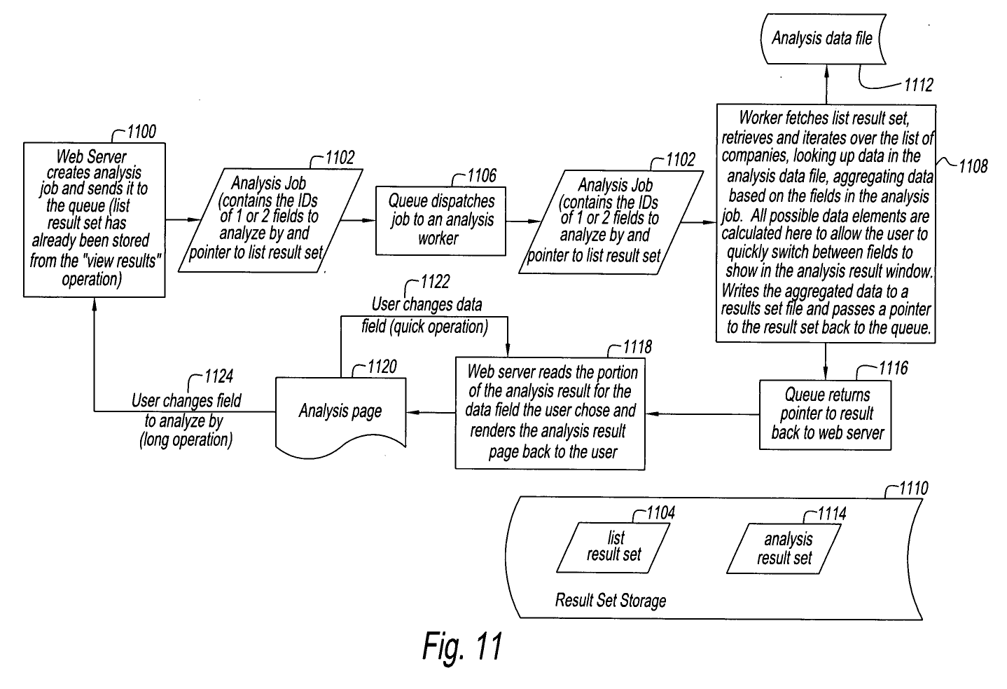

FIG. 11 shows an example list analysis process. In step 1100, the web server creates an analysis job 1102 and sends it to the queue. When this occurs, list result set 1104 has already been stored as a result of a view results operation requested by the user. The analysis job 1102 contains the identifiers of one or two fields to analyze by and a pointer to list result set 1104. In step 1106, the queue dispatches analysis job 1102 to an analysis worker. In step 1108, a worker fetches the list result set 1104. List result set 1104 is stored in result set storage 1110. Then, the worker retrieves and iterates over the list of companies from the list result set, looking up data in analysis data file 1112, aggregating data based on the fields in the analysis job 1102. All possible data elements are calculated to allow the user to quickly switch between fields to show in an analysis results window. Finally, in step 1108, the worker writes the aggregated data to the analysis result set file 1114 and passes a pointer to that result set back to the queue. In step 1116, the queue returns a pointer to a result back to the web server. In step 1118, the web server reads a portion of analysis result file 1114 for the data field chosen by the user and renders the analysis result page 1120 back to the user. If the user changes the data field (quick operation) 1122, control flows back to step 1118. If the user changes the data field to analyze by (long operation) 1124, control flows back to step 1100.

FIG. 12 shows an example count process. The count process is part of deleting, deduping, suppressing, and searching on primary and secondary SIC codes. First, a list count job contains a list of selections or settings as well as pointers to a list result set for any deleted records or suppression lists 1200. In step 1202, the job is dispatched to an analysis worker via a queue. In step 1204, the worker fetches the result sets for the selections or settings in the criteria 1206. The worker fetches the result sets for any suppression lists or deleted records that are pointed to in the job. If those result sets were created prior to the last data update, they are stored as DUNS Numbers and a conversion table 1208 is used to convert them back to row identifiers 1210, which are used for specialty contacts counts. Then, the worker combines all the sets together based on business logic and, if requested, dedupes the list (this uses the dedupe data 1212) and stores the counts (including some intermediate counts, e.g., dedupe count) and the set of companies in the list result set 1214. In step 1216, a queue returns a pointer to the result back to the web server. In step 1218, the web server reads the list result set and renders a results page 1220 with the count and pricing information. In step 1222, if a user licenses a list, it is saved for future use as a suppression list. Result set storage 1214 includes a delete result set 1224, a list result set 1226, a uploaded list result set for suppression 1228, and a licensed list result set for suppression 1230.

It is to be understood that the above description is intended to be illustrative and not restrictive. Many other embodiments will be apparent to those of skill in the art upon reviewing the above description, such as adaptations of the present disclosure to consumer mailing list, or other kinds of prospecting services. Various designs using hardware, software, and firmware are contemplated by the present disclosure, even though some minor elements would need to change to better support the environments common to such systems and methods. The present disclosure has applicability to various services, computer systems, and user interfaces beyond the example embodiments described, such as various database management systems, enterprise systems, and user interface systems. Therefore, the scope of the present disclosure should be determined with reference to the appended claims, along with the full scope of equivalents to which such claims are entitled.

1. A method of providing prospect lists, comprising:
providing tools for building a prospect list;
providing a list preview feature for previewing said prospect list prior to providing said prospect list;
providing a list analysis feature for analyzing said prospect list prior to providing said prospect list; and
providing said prospect list.

2. The method according to claim 1, further comprising:
providing a suppression feature for suppressing a suppression list from said prospect list.

3. The method according to claim 2, wherein said suppression list is a previously licensed prospect list.

4. The method according to claim 2, wherein said suppression list is an uploaded list.

5. The method according to claim 1, further comprising:
providing a dedupe feature for removing duplicate records in said prospect list.

6. The method according to claim 1, wherein said tools for building a prospect list include a search based on list selection criteria, said list selection criteria being selected from the group consisting of: location, industry, demographics, specialty data, and job function.

7. A system for providing prospect lists, comprising:
a web server for providing a user interface for providing prospect lists;
at least one database server for providing access to at least one database, said at least one database server being in communication with said web server;
a storage device for storing result set data; and
an application server for providing business logic for providing prospect lists, said application server being in communication with said web server, said at least one database server, and said storage device.

8. The system according to claim 7, wherein said database has transaction, metadata, and product data.

9. The system according to claim 7, further comprising:
a plurality of worker components in communication with said at least one database server, said storage device, and said application server.

10. The system according to claim 9, wherein said plurality of worker components includes a count engine cluster for determining counts of records.

11. The system according to claim 10, wherein said count engine cluster uses a set of index files in place of product data from said database server, whereby the speed of said count engine cluster is increased.

12. The system according to claim 9, wherein said plurality of worker components includes an analysis engine cluster for providing a list analysis feature.

13. The system according to claim 12, wherein data preparation steps are performed periodically on new data to produce data files for said list analysis feature, whereby a speed of said list analysis feature is increased.

14. The system according to claim 13, further comprising a layout of said data files comprises an order by record index so that each record of said data files is directly accessible by record index.

15. The system according to claim 9, wherein said plurality of worker components include a preview engine cluster for providing a list preview feature.

16. The system according to claim 9, wherein said plurality of worker components include an entity look-up engine cluster for performing an entity look-up.

17. The system according to claim 10, wherein said plurality of worker components include a list fabrication engine cluster for generating a list using said counts.

18. A computer-readable medium having executable instructions stored thereon to perform a method of providing previews of prospect lists, said method comprising:
sorting a list based on user-selected criteria;
providing a portion of said sorted list as a preview;
providing a selective delete feature for deleting elements of said sorted list from said preview; and
providing said list, said list having selected elements removed.

19. The computer-readable medium according to claim 18, further comprising:
storing said list, said deleted elements, and said preview.

20. The computer-readable medium according to claim 18, wherein said portion includes a company name and location.

21. A computer-readable medium having executable instructions stored thereon to perform a method of suppressing lists from prospect lists, said method comprising:
building a current prospect list based on list selection criteria;
removing elements in a suppression list from said current prospect list to generate a new prospect list; and
providing said new prospect list.

22. The computer-readable medium according to claim 21, further comprising:
storing said suppression list.

23. The computer-readable medium according to claim 21, wherein said suppression list is a previously acquired list.

24. The computer-readable medium according to claim 21, wherein said suppression list is an uploaded list.

25. The computer-readable medium according to claim 24, further comprising:
processing said uploaded list to produce a list result set having unique corporate identifiers.

26. The computer-readable medium according to claim 25, further comprising:
associating said list result set with a user account.

27. The computer-readable medium according to claim 25, wherein said processing uses a conversion table.

28. The computer-readable medium according to claim 25, wherein said unique corporate identifiers are associated with elements in said uploaded list through application of a matching process.

29. A computer-readable medium having executable instructions stored thereon to perform a method of providing list analysis for prospect lists, said method comprising:
receiving an analysis data file;
retrieving a list result set;
processing a list of companies by looking up data in said analysis data file and aggregating said data based on selected fields; and
displaying at least a portion of said aggregated data.

30. The computer-readable medium according to claim 29, further comprising:
storing said aggregated data in a result set file.

31. The computer-readable medium according to claim 29, wherein more than said portion is available for display without further processing.

32. The computer-readable medium according to claim 29, wherein said data files are ordered by record index so that each record of said data files is directly accessible by record index, wherein said record index is included as a data item in each record.

33. A computer-readable medium having executable instructions stored thereon to perform a method of providing counting items in prospect lists, said method comprising:
receiving a list;
retrieving a result set corresponding to said list;
retrieving any suppression lists or delete lists referenced in said list;
combining said list with any said suppression lists or delete lists to form a combined list; and
providing said combined list.

34. The computer-readable medium according to claim 33, further comprising:
deduping said combined list, upon request.

35. The computer-readable medium according to claim 33, further comprising:
converting said result set using a conversion table, if a data update occurred after said result set was stored.
